(19) United States
(12) Patent Application Publication
(10) Pub. No.: US 2024/0195234 A1
(43) Pub. Date: Jun. 13, 2024

(54) STATOR FOR A ROTATING ELECTRICAL MACHINE

(71) Applicant: hyperdrives GmbH, München (DE)

(72) Inventor: Michael Fick, München (DE)

(73) Assignee: hyperdrives GmbH, München (DE)

(21) Appl. No.: 18/286,916

(22) PCT Filed: Apr. 14, 2021
(86) PCT No.: PCT/EP2021/059656

§ 371 Date: Oct. 13, 2023

(51) Int. Cl. H02K 1/14; H02K 1/18; H02K 3/34; H02K 15/02

(52) U.S. Cl. CPC H02K 1/148; H02K 1/18; H02K 3/345; H02K 15/026

(57) ABSTRACT

The invention relates to a stator for an electrical radial flux machine having a distributed winding and an internal rotor design, comprising: a toothed star-shaped element having multiple teeth, wherein stator grooves are provided between the teeth in the circumferential direction and wherein the teeth are connected by means of one or more bridges in the region facing an air gap between the stator and the rotor, and a yoke ring, wherein the toothed star-shaped element is accommodated, at least in sections, within the yoke ring.

### FIELD OF THE INVENTION

The invention relates to a stator for a rotating electrical machine with a distributed winding designed as a radial flux machine with an internal rotor and an electrical machine with such a stator. The invention further relates to a method of assembling a stator.

### BACKGROUND OF THE INVENTION

Electrical machines use the properties of the electromagnetic interaction and the evoked magnetic force effects between stator and rotor. Electrical machines can be motor-driven or generator-driven. There are various topologies of rotating electrical machines with one (or more) stator(s) and one (or more) rotor(s) mounted so as to be movable in relation thereto.

Generally, these electrical machines are named according to the plane in which the magnetic flux lines propagate and interact, e.g. radial, axial or transverse flux machines.

Moreover, a distinction is made between concentrated and distributed windings.

Concentrated windings (also referred to as plug-in or toothed coils) have compact winding heads and are relatively easy to manufacture.

The main advantage of distributed windings is that the magnetomotive force in the air gap between the stator and the rotor of the machine has less harmonic content, i.e. a smaller proportion of undesirable harmonics of the magnetomotive force. This results in high performance of the electrical machine with low rotor losses, low noise generation and few vibration problems.

In purely battery-electric and mass-produced vehicles, radial flux motors with a distributed winding and internal rotor are therefore used almost exclusively as drive motors.

The most important configurations of distributed windings are:
1) Round wire winding which is drawn into the stator through the groove openings.
2) Bar winding in the form of many individual hair pins which are inserted axially into the grooves of the stator and subsequently mechanically formed into a meander-shaped “wave winding” and interconnected by means of laser or resistance welding of the bar ends.
3) Continuous bar winding (“continuous hair pin”) which is prefabricated as meander-shaped wave winding and wound onto a carrier tool or mandrel and subsequently placed in the bore of the stator and spread out into the grooves of the stator.

In particular the above-stated bar windings 2) and 3) are becoming increasingly widespread on the e-mobility market. Another configuration of the distributed winding, which is mainly used in large electrical machines such as turbo generators, is the
4) traction coil winding in which the individual identical traction coils are inserted into grooves from inside through bore of the stator.

The configurations 3) and 4) have in common that the distance between two adjacent tooth tips at the respective ends of the stator teeth adjacent to the air gap between the stator and the rotor must be configured to be at least wide enough to allow the bar winding or traction coil winding to be inserted through this opening into the groove of the stator during assembly.

In hair pin windings (see configuration 2)), this restriction does not arise since the bars are inserted axially and not radially. In round wire windings (see configuration 1)), the conductor bundle has greater flexibility and can be drawn in through comparatively narrow groove openings. In configurations 3) and 4), tooth tips can thus only be configured to be very small or cannot be provided at all. In general, and depending on the dimensioning of the tooth width and load of the soft-magnetic iron of the tooth, pronounced tooth tips are advantageous with regard to torque yield, low cogging and reduced rotor losses.

Furthermore, the above-described method of radially inserting the winding from the inside of the bore of the stator into its grooves entails geometrical limitations, in particular for the winding types 3) and 4), since the bar winding or the traction coils must first be compressed before they are in their final and installation position in the grooves. Apart from the general space restriction in device and automation technology in the stator bore, the compression of the conductor bars finally lying axially in the grooves and stacked radially on top of each other also causes a deformation of the winding heads that must remain movable with respect to each other during the insertion process and may not touch or overlap.

The greater the curvature of the stator segment enclosed by a coil and the greater the angle between the perpendiculars of the respective conductor bars extending radially through the rotational axis of the electrical machine, the more restrictions arise when configuring the winding in accordance with the above-stated geometrical limitations.

In summary, the described relationships result in a limitation of the ratio of the bore diameter of the stator to its number of grooves and to the number of conductor bars in a groove. Winding types 3) and 4) thus require an electrical machine with a relatively large diameter and many grooves or a comparatively low number of conductor bars on top of each other.

Accordingly, there is a need for a stator configuration that allows the distributed winding to be inserted from the outside without geometrical and manufacturing constraints, which would result in an optimally designed electrical machine with high efficiency and the potential for a high degree of automation and low manufacturing costs. Furthermore, there is a need for a stator configuration that has pronounced tooth tips, which would result in an electrical machine with high torque yield, low cogging and reduced rotor losses.

While stators with a concentrated winding in which the stator is divided (for example CN203086252U) already exist, such arrangements are not known for stators with a distributed winding.

### SUBJECT MATTER OF THE INVENTION

An object of the invention is to provide a stator for an electrical radial flux machine having an internal rotor design with a distributed winding, which enables the insertion of the distributed winding from outside without or with reduced geometrical and manufacturing constraints.

According to the invention, a stator according to claim 1 is provided. Further preferred embodiments are specified in the dependent claims and described below.

The stator for an electrical radial flux machine having an internal rotor design with a distributed winding, comprises: a toothed star-shaped element having multiple teeth, wherein stator grooves are provided between the teeth in the circumferential direction and wherein the teeth are connected by means of one or more bridges in the region facing an air gap between the stator and the rotor; and a yoke ring, wherein the toothed star-shaped element is accommodated, at least in sections, within the yoke ring.

The stator according to the invention has the advantage that it is made possible to insert the winding without effort or with greatly reduced effort, whereby an optimally designed electrical machine with high efficiency can be provided, which can thereby be manufactured with a high degree of automation. In this way, such a stator can be produced with comparatively low manufacturing costs.

A winding can be accommodated in the stator grooves. In this regard, the winding is provided as a distributed winding. One of the advantages of a distributed winding is that the magnetomotive force in an air gap between the stator and the rotor of the machine has less harmonic content.

One aspect is therefore a stator arrangement for an electrical radial flux machine having an internal rotor with a distributed winding, in which the teeth between the stator grooves can be separated from the yoke (hereinafter referred to as the “yoke ring”).

The teeth can be connected with each other by means of one or more (in particular thin) bridges—preferably two bridges—at the air gap between the stator and the rotor so as to form a toothed star-shaped element.

Furthermore, the invention enables the configuration of pronounced tooth tips, resulting in an electrical machine with high torque yield, low cogging and reduced rotor losses. The teeth are connected with each other by means of one or more thin bridges—preferably two bridges—at the air gap between the stator and the rotor and form a toothed star-shaped element. The bridge located at the air gap between the stator and the rotor can be configured individually and optimally in electromagnetic terms, and thus replaces the classic tooth tip.

The contact surfaces of the tooth backs to the yoke ring are configured in a specific design with a portion for a form-fitting connection. A positive partially circular contour is illustrated below. Alternative geometries, for example in trapezoidal or triangular form, are also possible; pointing radially outward (“positive”) or inward toward the rotational axis of the electrical machine (“negative”).

Furthermore, according to an embodiment, the yoke ring can be segmented along its circumference and/or the toothed star-shaped element can be segmented along its circumference. Either the yoke ring can be segmented, both the yoke ring and the toothed star-shaped element, or only the toothed star-shaped element. The segmentation also enables cost-effective and highly automated manufacturing.

The toothed star-shaped element and/or the yoke ring (or the segments of the toothed star-shaped element and/or the yoke ring) can be made of layered/laminated sheets.

The segmentation of the toothed star-shaped element can make it possible, in particular, to use grain-oriented sheets in the segments of the toothed star-shaped element. Such grain-oriented electrical steel sheets, which are known from transformer construction and are increasingly used in axial flux machines, have a preferred magnetic direction. Along its preferred magnetic direction, a grain-oriented steel sheet exhibits significantly lower remagnetization losses compared to a conventional non-grain-oriented electrical steel sheet, as well as higher magnetizability, which means that a lower field can be applied to achieve comparable magnetic field strengths.

Due to the use of grain-oriented steel sheets, an electrical machine with higher power density and lower losses can be realized. Thus, it represents a cost-effective alternative to electrical machines with very finely laminated stators or with stators made of cobalt-iron sheets, which has a higher saturation polarization but is significantly more expensive.

Furthermore, the segmentation along the circumference can serve to punch the sheet segments from strip material with a good utilization of the material and with a cost-effective and simpler tool in only one cut, compared to a progressive punching tool, in order to realize low manufacturing costs.

It was described at the beginning that the teeth are connected with each other by means of one or more thin bridges at the air gap between the stator and the rotor and thus form a toothed star-shaped element. The thin bridge is preferably to be configured as a double bridge to impart more strength to the toothed star-shaped element or the segments of the toothed star-shaped element. According to this embodiment, the teeth are connected with each other by means of two bridges and a recess (hereinafter also referred to as “clearance”) is formed between the two bridges. The clearance (“recess”) between the bridges can be configured in such a way, considering the optimal tooth tip geometry, that the clearance maps parts of a circle, i.e. provides a circular geometry for a rod to pass through.

According to a further embodiment, it is provided that the toothed star-shaped element is segmented by a plurality of rings, wherein it is preferred that the segments of the toothed star-shaped element are arranged so as to be staggered with respect to each other in the axial direction. This arrangement can be used in particular for an arrangement in which the toothed star-shaped element has a plurality of segments in the circumferential direction.

In order to fix the toothed star-shaped element rings and/or the toothed star-shaped element segments during the assembly of the toothed star-shaped element and in order to impart mechanical stability to the packet of individual sheets, rods or bolts made of preferably electrically non-conductive material or material with reduced electrical conductivity can be pushed through these circular recesses (clearances) in the axial direction of the machine. If the toothed star-shaped element is segmented into individual toothed star-shaped element segments, it thus becomes possible to interleave the segment packets of the toothed star-shaped element along the rotational axis of the machine. The interleaving of the individual packets serves to improve the mechanical stability of the arrangement. In addition, standard lengths can be manufactured and the machine can be scaled cost-effectively in this way with standard packets. For example, stainless steel, ceramic and/or plastic can be used as electrically non-conductive material or material with reduced electrical conductivity.

Instead of or in addition to the bolts, tubes can be inserted into the recesses between the bridges. A cooling medium can be guided through these tubes, which are located between the winding and the air gap of the stator and the rotor, in order to provide an effective cooling of the stator and, above all, the rotor of the electrical machine. This type of cooling leads to a higher power density of the electrical machine, since the stator and the rotor are cooled better and the machine can thus be utilized to a greater extent. The tubes can be made of an electrically non-conductive or poorly conductive material or material with reduced electrical conductivity, e.g. stainless steel, ceramic and/or plastic.

It is preferred that the yoke ring is configured in a segmented manner in such a way that the yoke ring segments have connecting portions for a form-fitting connection. In this way, for example, torque can be transmitted between the stator and a housing surrounding the stator.

It is preferred that the yoke ring is configured in a segmented manner in such a way that the yoke ring is segmented in the axial direction. In this regard, the yoke ring segments can have eyelets for fixing the yoke ring and thus the entire stator by means of rods or tubes. By means of said rods or tubes, a torque of the stator can be transmitted to the end shields. By means of the tubes, a coolant can be guided to cool the yoke ring of the stator.

In particular, it can be provided that the yoke ring is segmented in such a way that the yoke ring is segmented both along the circumference of the stator and in the axial direction.

Segmenting the yoke ring into yoke ring segments along its circumference is advantageous since a closed yoke ring can no longer be pushed axially over the toothed star-shaped element from the outside after the winding has been inserted, since the winding heads protrude beyond the inner diameter of the yoke ring in the radial direction, especially in the case of traction coils, and thus prevent it from being pushed on along the rotational axis (axially). In special cases, this limitation can be overcome by an asymmetrical configuration of the winding heads of the traction coil winding.

Segmenting the yoke ring into yoke ring segments provides the same advantages in terms of punchability and axial scaling as described for the segments of the toothed star-shaped element.

In a specific embodiment, the yoke ring segment has elevations on the two outer sides. These elevations serve as form-fitting anti-rotation device similar to a tongue-and-groove connection to a housing surrounding the stator packet.

In a further embodiment, the yoke ring segment has one or more eyelets. Rods can be pushed through the bore of the eyelets to fix the yoke ring segments in order to form a stable yoke ring. This embodiment is particularly advantageous since it allows the omission of the housing surrounding the stator packet, which is a costly component. In electrical machines that are integrated in gears with direct oil cooling of the stator or in machines with direct waveguide cooling of the winding, said housing is not absolutely necessary for the sake of cooling since the indirect cooling function via the housing is replaced with the direct cooling at the stator iron or in the winding itself.

The embodiment of two eyelets per yoke ring segment is particularly advantageous since the stator packet becomes more stable by axial rotation of the rings of yoke ring segments and the yoke ring segments are fixed to each other via axial rods through the eyelets, without the need for an additional component to secure the yoke ring segments.

It is preferred that a groove insulation is provided around the winding in the stator grooves. In this respect, it can be provided that the groove insulation is configured in two parts, wherein the toothed star-shaped element, in a further embodiment of the toothed star-shaped element or segment of the toothed star-shaped element, has a step in the groove in the direction of the outer diameter. This step is intended to create space for the two-part groove insulation, which is configured in the form of a double U-layer.

Furthermore, according to the invention, a method for assembling a stator is provided, in particular a stator according to one of the preceding aspects. The method comprises the steps of:
providing a toothed star-shaped element having multiple teeth, wherein stator grooves are provided between the teeth in the circumferential direction and wherein the teeth are connected by means of one or more bridges in the region facing an air gap between the stator and the rotor; and
attaching a yoke ring along the rotational axis of the motor around the toothed star-shaped element.

According to said method, the assembly of the stator can be simplified significantly.

According to an embodiment, a winding with a distributed arrangement is inserted into the stator grooves.

The sequence during assembly of the stator can be as follows when using a toothed star-shaped element comprising toothed star-shaped element segments:
1. Arranging segments of the toothed star-shaped element around and along the rotational axis of the motor relative to the toothed star-shaped element; fixing with bolts, pins or tubes.
2. Inserting first layer of groove insulation into groove.
3. Inserting winding/coils.
4. Attaching second layer of groove insulation.
5. Attaching and fixing yoke ring (segments) around and along the rotational axis of the motor around the toothed star-shaped element, complete with winding and groove insulation.
6. Final mechanically robust fixing of the stator arrangement by inserting rods into the eyelets of the yoke ring or by shrinking on a housing.

Steps 2 and 4 can be omitted when inserting a winding without groove insulation.

The embodiments listed above can be used individually or in any combination, deviating from their interdependencies in the claims, to configure the arrangements according to the invention.

These and other aspects of the invention are shown in detail in the figures as follows.

### BRIEF DESCRIPTION OF THE FIGURES

FIG. 1a shows an unsegmented toothed star-shaped element and an unsegmented yoke ring for a stator of a radial flux machine having an internal rotor with a distributed winding according to a first embodiment in which the two components are illustrated individually in a section perpendicular to the rotational axis of the stator;

FIG. 1b shows the toothed star-shaped element and the yoke ring according to FIG. 1a in the assembled state;

FIG. 2a shows a toothed star-shaped element segment of a segmented toothed star-shaped element for a stator according to a first embodiment in a section perpendicular to the rotational axis of the stator;

FIG. 2b shows the segmented toothed star-shaped element according to the first embodiment with a grain-oriented sheet in a section perpendicular to the rotational axis of the stator;

FIGS. 3a to 3c show various modifications of segments of the toothed star-shaped element for a stator according to the invention with a double bridge and partially circular recess (FIG. 3a), with an additional recess for a two-part groove insulation (FIG. 3b), and with only bridge (FIG. 3c), in a section perpendicular to the rotational axis of the stator;

FIG. 4a shows a segment of the toothed star-shaped element according to a further modification with bolts;

FIG. 4b shows a segmented toothed star-shaped element composed of such segments in a partially interleaved manner, according to a further modification, in a perspective view;

FIG. 5a shows a segment of the toothed star-shaped element of a further modification of a stator according to the invention with a segmented toothed star-shaped element, groove insulation and winding in a section perpendicular to its rotational axis;

FIG. 5b shows a segment of the toothed star-shaped element according to FIG. 5a in a perspective view;

FIG. 6a shows a segmented yoke ring of a first modification for a stator according to the invention in a section perpendicular to the rotational axis of the stator;

FIGS. 6b to 6c show various modifications of the yoke ring segments in a section perpendicular to the rotational axis of the stator;

FIG. 7 shows a second embodiment of a stator according to the invention with a segmented yoke ring, anchored by rods in the eyelets and without housing, in a perspective view;

FIG. 8a shows a portion of a third embodiment of a stator according to the invention, complete with insulation, winding and segmented yoke ring, as well as tubes for cooling, in a section perpendicular to the rotational axis;

FIG. 8b shows the stator according to the third embodiment in a perspective view;

FIG. 9 shows the stator of the third embodiment (FIGS. 8a and 8b) of the stator according to the invention, inserted into a housing with integrated cooling passages, in a perspective view;

FIG. 10a shows a segmented yoke ring according to a further modification with a staggered arrangement;

FIG. 10b shows a detailed view of a yoke ring segment of the yoke ring according to FIG. 10a;

FIG. 11 shows a portion of a stator according to a fourth embodiment, wherein the yoke ring segments are configured in block form.

### DETAILED DESCRIPTION OF THE EMBODIMENT EXAMPLES

Exemplary embodiments of the invention are described by means of the figures. Individual features of the embodiments as well as their modifications can be combined with each other to form further embodiments.

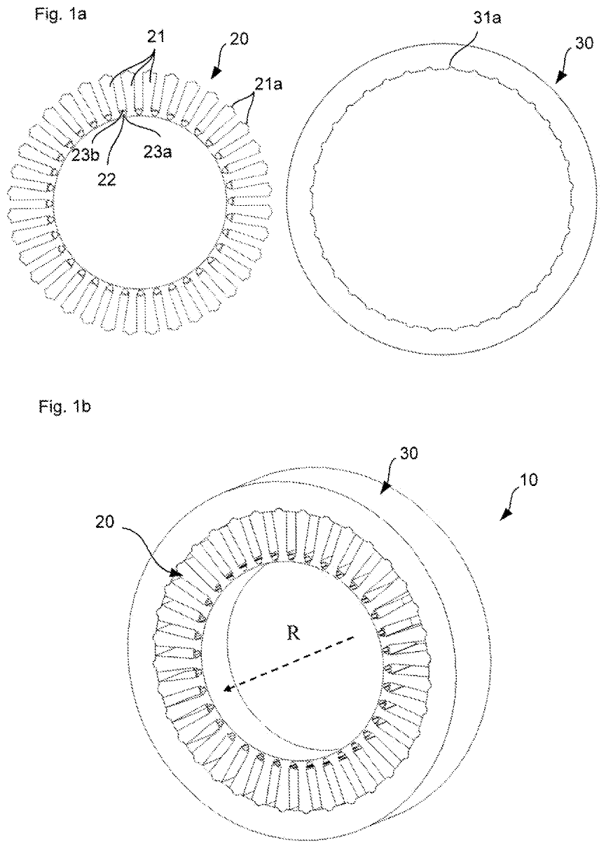

FIG. 1b shows a first embodiment of a stator 10 according to the invention of a radial flux machine having an internal rotor with a distributed winding, comprising an (unsegmented) toothed star-shaped element 20 and an (unsegmented) yoke ring 30. Both components are made of a soft-magnetic material, usually electrical steel sheet, which is finely laminated in the direction of the rotational axis R in order to suppress eddy current losses in the iron. A configuration made of sintered iron (SMC) would also be possible.

The figures show the two components first in a section perpendicular to rotational axis R of the stator (FIG. 1a) and in the assembled state of the stator 10, but without winding and insulation around the winding, in a perspective view (FIG. 1b).

The toothed star-shaped element 20 has a plurality of teeth 21 which comprise protrusions 21a on an outer circumferential side. The protrusions 21a can be inserted into recesses 31a of the yoke ring 30 in order to connect the toothed star-shaped element 20 with the yoke ring 30 in a form-fitting manner.

The teeth 21 are spaced apart from each other in such a way that, in the assembled state, the windings with the insulation system can be accommodated in the grooves formed between the teeth 21. The teeth 21 are connected with each other by two bridges 23a, 23b, wherein the bridges 23a, 23b are formed between a groove and a recess 22 as well as the recess 22 and an inner circumferential side of the toothed star-shaped element 20. In the embodiment example, the recess 22 has a partially circular segment as well as a segment extending along the groove. For example, the bridges 23a, 23b can be configured so as to be relatively thin by means of punching of the recess 22.

During assembly, windings are inserted into the grooves between the teeth 21 and, subsequently, the toothed star-shaped element 20 is pushed into the yoke ring 30 in such a way that the protrusions 21a of the teeth 21 are inserted into the recesses 31a of the yoke ring 30.

Furthermore, the strength of the individual soft-magnetic sheets in relation to each other can be increased by pinning through the clearance of the recess or the (partially) circular gap can be used to integrate tubes for cooling in the stator.

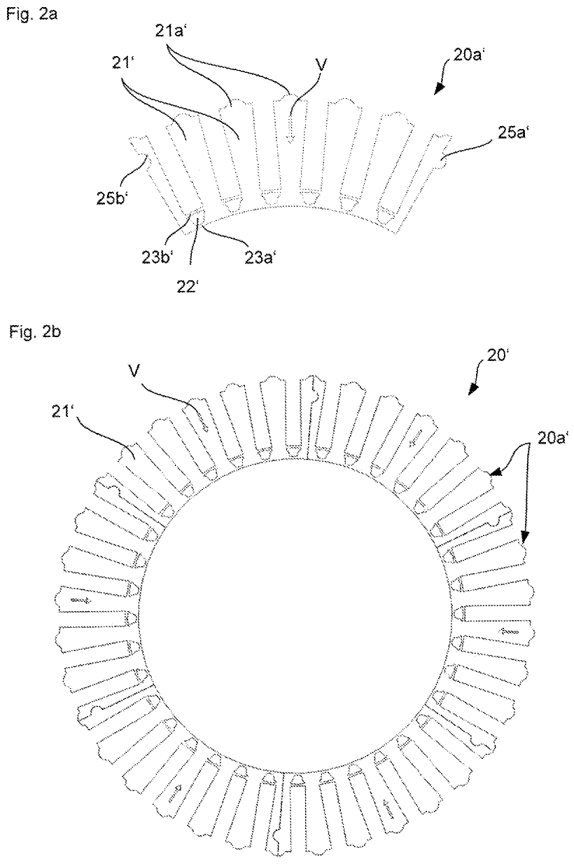

FIG. 2a shows a toothed star-shaped element segment 20a′ of a segmented toothed star-shaped element 20′ for a stator in a section perpendicular to its rotational axis. The toothed star-shaped element 20′, which can be inserted e.g. into a yoke ring 30 according to FIG. 1a, is configured in a segmented manner and is composed of individual segments 20a′ of the toothed star-shaped element. The segments 20a′ of the toothed star-shaped element are made of grain-oriented sheet which has a preferred magnetic direction V pointing radially to the rotational axis of the stator.

A segment 20a′ of the toothed star-shaped element comprises multiple teeth 21′ which are provided with protrusions 21a′, similar to the teeth of the toothed star-shaped element of the first embodiment. Furthermore, the teeth 21′ are connected with each other by bridges 23a′ and 23b′, wherein the bridges 23a′ and 23b′ are separated from each other by a recess 22′.

The outer teeth 21′ of the segment 20a′ of the toothed star-shaped element in the circumferential direction are divided and have a fastening protrusion 25a′ (in FIG. 2a the tooth, which points to the right-hand side, of the segment 20a′ of the toothed star-shaped element) as well as a fastening notch 25b′ (in FIG. 2a the tooth, which points to the left-hand side, of the segment 20a′ of the toothed star-shaped element) so that adjacent segments 20a′ of the toothed star-shaped element can be connected with each other by engagement of the fastening protrusion 25a′ of a segment of the toothed star-shaped element with the fastening notch 25b′ of an adjacent segment of the toothed star-shaped element by means of a form-fitting connection. In FIG. 2b, the toothed star-shaped element 20′ is illustrated in the assembled state.

During assembly, windings are inserted into the grooves between the teeth 21′ and, subsequently, the complete toothed star-shaped element 20′ is pushed into a yoke ring in such a way that the protrusions 21a′ of the teeth 21′ are introduced into corresponding recesses of the yoke ring.

An increased stability of individual segments 20a′ of the toothed star-shaped element in relation to each other can be achieved additionally by means of the fastening protrusion 25a′ and the fastening notch 25b′, wherein the fastening protrusion 25a′ is realized, by way of example, in the form of a partial circle in the embodiment described here. Further form-fitting geometries can be freely selected and combined in order to realize a radial and tangential interlocking of the segments 20a′ of the toothed star-shaped element with respect to and between each other.

The same applies in analogy to the protrusions 21a′ at the outer diameter of the tooth 21′ that is supposed to interlock the toothed star-shaped element with respect to the yoke ring in a form-fitting manner.

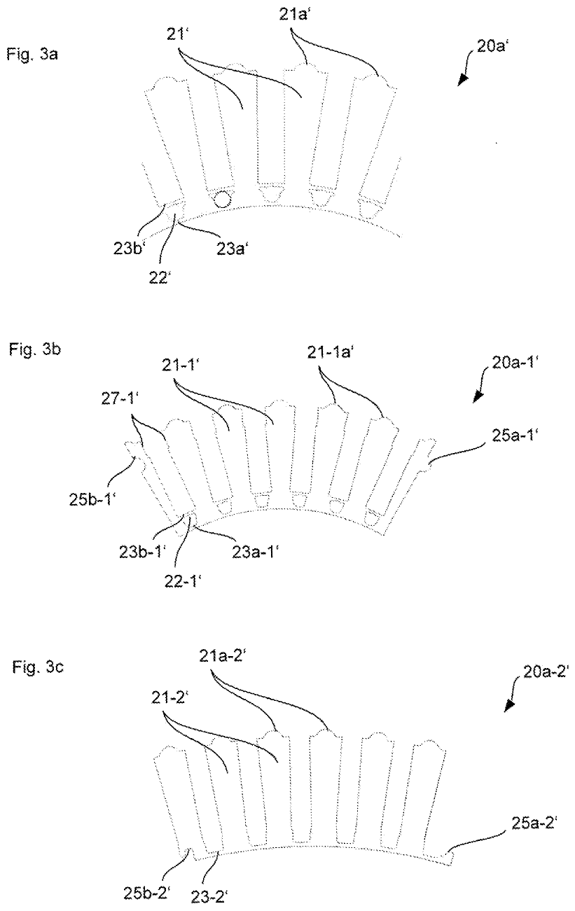

FIG. 3a shows in detail a portion of the segment 20a′ of the toothed star-shaped element, as shown in FIG. 2a. Further modifications of segments of the toothed star-shaped element with two bridges 23a-1′, 23b-1′ (FIG. 3b) and one bridge 23-2′ (FIG. 3c), each in a section perpendicular to the rotational axis of the stator, are illustrated in the further figures.

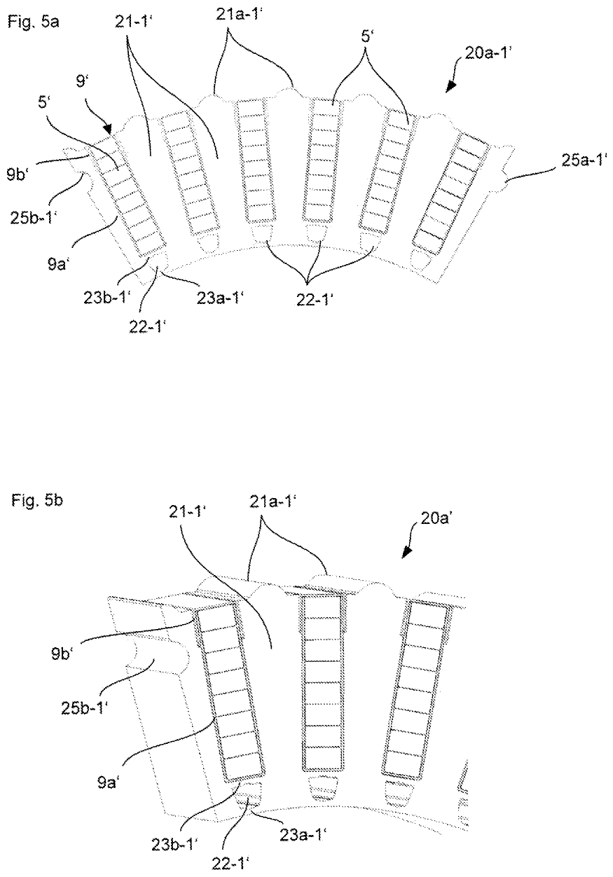

The segment 20a-1′ of the toothed star-shaped element, as shown in FIG. 3b, comprises multiple teeth 21-1′ provided with protrusions 21-1a′. The teeth 21-1′ are connected with each other by means of bridges 23a-1′ and 23b-1′, wherein the bridges 23a-1′ and 23b-1′ are separated from each other by a recess 22-1′. The modification illustrated in FIG. 3b differs from the modification according to FIG. 3a in the configuration of the recess 22-1′. Furthermore, the segment 20a′ of the toothed star-shaped element has recesses 27-1′ so as to provide space for a two-part groove insulation (in this regard, see FIG. 5).

Similar to the embodiment shown in FIG. 3a, the outer teeth 21-1′ of the segment 20a-1′ of the toothed star-shaped element in the circumferential direction are divided and have a fastening protrusion 25a-1′ (in FIG. 3a the tooth, which points to the left-hand side, of the segment 20a-1′ of the toothed star-shaped element) as well as a fastening notch 25b-1′ (in FIG. 3a the tooth, which points to the right-hand side, of the segment 20a-1′ of the toothed star-shaped element) so that adjacent segments 20a-1′ of the toothed star-shaped element can be connected with each other by engagement of the fastening protrusion 25a-1′ and a fastening notch 25b′ of an adjacent segment of the toothed star-shaped element.

During assembly, windings are inserted into the grooves between the teeth 21-1′ and, subsequently, the complete toothed star-shaped element is pushed into a yoke ring in such a way that the protrusions 21a-1′ of the teeth 21-1′ are introduced into corresponding recesses of the yoke ring.

The segment 20a-2′ of the toothed star-shaped element, as shown in FIG. 3c, comprises multiple teeth 21-2′ provided with protrusions 21-2a′. The teeth 21-2′ are connected by means of a bridge 23-2′. The modification illustrated in FIG. 3c differs from the modification according to FIG. 3a and FIG. 3b in that in this configuration no recess for providing two bridges is provided. In other words, the modification illustrated in FIG. 3c comprises a bridge between adjacent teeth.

The outer segments 20a-2′ of the toothed star-shaped element in the circumferential direction have a fastening protrusion 25a-2′ (in FIG. 3c the tooth, which points to the right-hand side, of the segment 20a-2′ of the toothed star-shaped element) as well as a fastening notch 25b-2′ (in FIG. 3c the tooth, which points to the left-hand side, of the segment 20a-2′ of the toothed star-shaped element) so that adjacent segments 20a-2′ of the toothed star-shaped element can be connected with each other by engagement of the fastening protrusion 25a-2′ and a fastening notch 25b-2′ of an adjacent segment of the toothed star-shaped element.

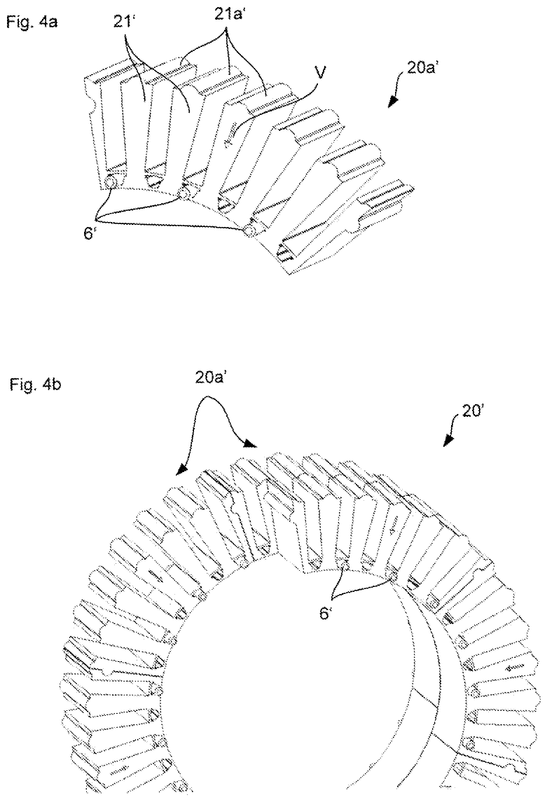

FIG. 4a shows a segment 20a′ of the toothed star-shaped element and FIG. 4b shows a toothed star-shaped element 20′ consisting of multiple toothed star-shaped element segments not yet fully assembled, each in a perspective view.

The individual soft-magnetic sheets are fixed together by bolts 6′ to form a segment 20a′ of the toothed star-shaped element. In a further embodiment, only every other clearance (recess) is occupied by a bolt 6′ and, in a further embodiment, the bolts 6′ are longer than the axial length of the segment of the toothed star-shaped element. By a corresponding division of the toothed star-shaped element 20a′ into a plurality of rings along the rotational axis of the stator according to the invention and by offsetting (“staggering”, “interleaving”) the segment rings 20a′ by one or more teeth it is supposed to be achieved that the preferred magnetic direction V is equally distributed around the circumference of the stator and also that the mechanical interruption between adjacent segments 20a′ of the toothed star-shaped element is equally distributed around the rotational axis of the stator.

To provide the bolts 6′ cost-effectively, they are preferably configured so as to be cylindrical and chamfered; however, alternative geometries of this component are also possible if specific tooth tip geometries turn out to be advantageous in electromagnetic terms.

FIG. 5a shows a further embodiment of the segmented toothed star-shaped element segment 20a-1′ complete with winding 5′ and groove insulation 9′ in a section perpendicular to the rotational axis of a stator according to the invention, and FIG. 5b shows a perspective view thereof.

The groove insulation 9′ can, but does not have to be configured in two parts. In the embodiment example, a two-part groove insulation 9′ is provided with a first layer 9a′ and a second layer 9b′. A two-part configuration can have advantages for the technical process during assembly of the winding 5′ radially from the outside. First, the first U-shaped layer 9a is inserted into the groove; subsequently, the distributed winding 5′ is pushed in or threaded on and, finally, the second layer groove insulation 9b′ is pushed over the outer conductors of the winding in the radial direction, and therefore a step is provided in the tooth 21-1′ of the segment 20a′ of the toothed star-shaped element to accommodate the second layer 9b′ of the groove insulation 9′.

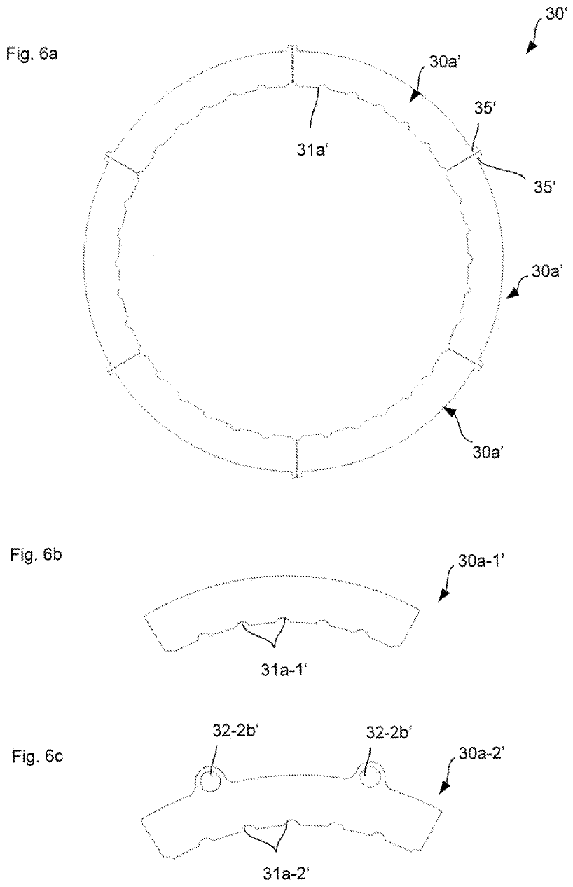

FIG. 6a shows an embodiment of a segmented yoke ring 30′, comprising yoke ring segments 30a′ which are joined together to form the yoke ring 30′.

Due to the segmented arrangement of the yoke ring 30′, the structure of the stator loses some of its mechanical strength and rigidity compared to the standard one-piece design of stators in order to transmit torques safely via the usual interference fit between the stator and housing. To safely transmit the torque, specific configurations of the segmented yoke ring 30′ with mechanical connecting portions 35′ integrated into the yoke ring segments 30a′ are therefore recommended. The yoke ring segments 30a′ have recesses 31a′. During assembly, a toothed star-shaped element is pushed into the yoke ring 30′ in such a way that protrusions of the teeth of the toothed star-shaped element are inserted into the recesses 31a′ of the yoke ring 30′.

FIG. 6b shows a modification of a yoke ring segment 30a-1′ which differs from the yoke ring segment 30a′ illustrated in FIG. 6a in that no connecting portions are provided. However, similar to the yoke ring segment 30a′ illustrated in FIG. 6a, the yoke ring segment 30a-1′ has recesses 31-1a′.

In the modification illustrated in FIG. 6c, the yoke ring segment 30a-2′ is configured with one or more eyelets 32-2b′ for securing the stator against rotation and fixing it by means of rods through the eyelets 32-2b′ of the yoke ring segments 30a-2′ and with anchoring in the end shields of the electrical machine. Circular eyelets are particularly advantageous since tubes or rods can be provided cost-effectively. Moreover, the specific configuration with two eyelets per yoke ring segment is particularly advantageous since the yoke ring segments 30a-2′ can be interleaved around the half of such a segment. In a further specific embodiment, coolant is additionally guided through the tubes to provide additional cooling for the stator.

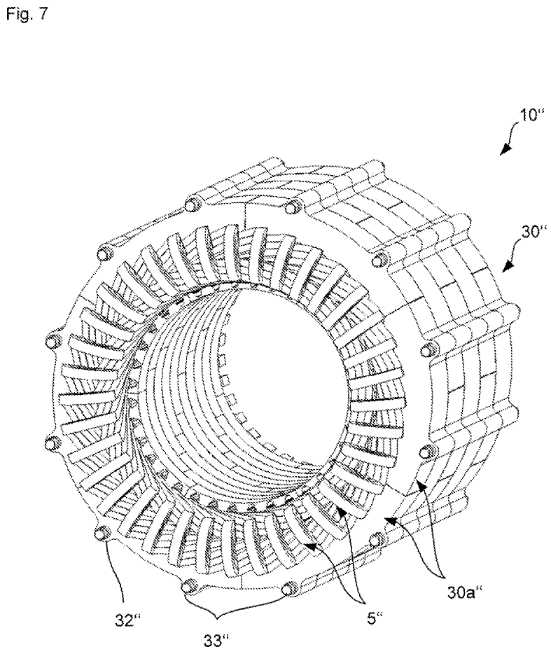

FIG. 7 shows such a stator 10″ according to the invention with a winding 5″ without a housing and with a segmented yoke ring 30″, anchored by rods 33″ in eyelets of the yoke ring segments 30a″ with interleaving of the segmented yoke rings 30a″ as illustrated in FIGS. 6a, 6b, in a perspective view.

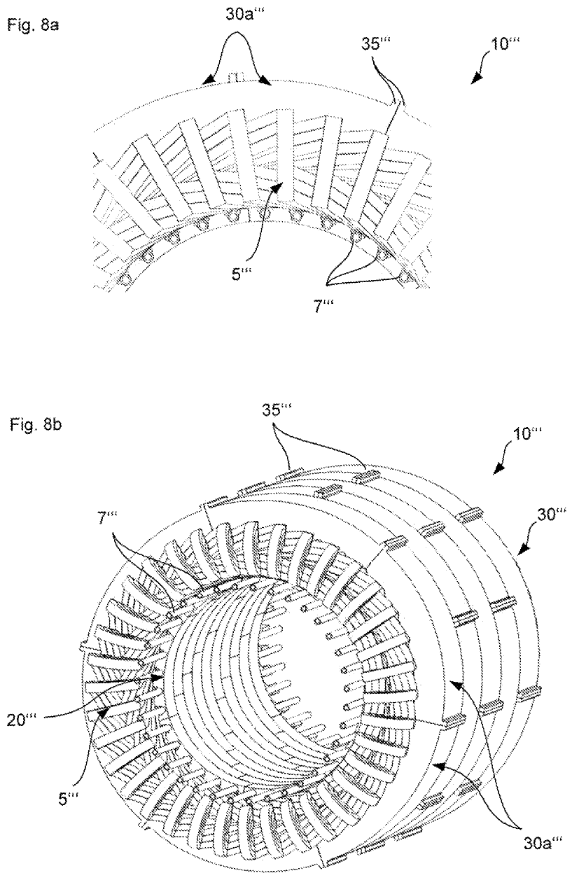

FIG. 8a shows a portion of a third embodiment of a stator 10′″ according to the invention, with a winding 5′″ without a housing and with a segmented yoke ring 30′″. In FIG. 8b, the yoke ring segments 30a′″ are illustrated in a form-fitting manner and interleaved with each other in a perspective view in a section perpendicular to the rotational axis. Furthermore, this stator has tubes 7′″ for guiding a coolant therethrough in a recess between the bridges (see, in this regard, e.g. FIG. 3a or FIG. 3b) of the segmented and interleaved toothed star-shaped element 20′″ for providing a very efficient cooling of the stator and in particular of the rotor of the electrical machine. The tubes 7′″ can be made of stainless steel, ceramic and/or plastic.

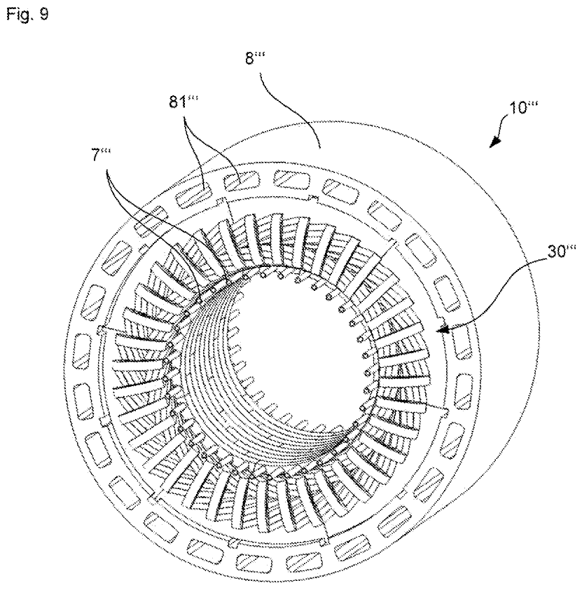

FIG. 9 shows the same stator 10′″ according to the invention pursuant to FIG. 8b with tubes 7′″ for efficient cooling of the machine extended by an outer housing 8′″ with further cooling passages 81′″ in a perspective view.

Further embodiments of the stator according to the invention without cooling passages in the housing, but alternatively with direct cooling by waveguides, can be arbitrarily combined and derived from these features and all other features described above.

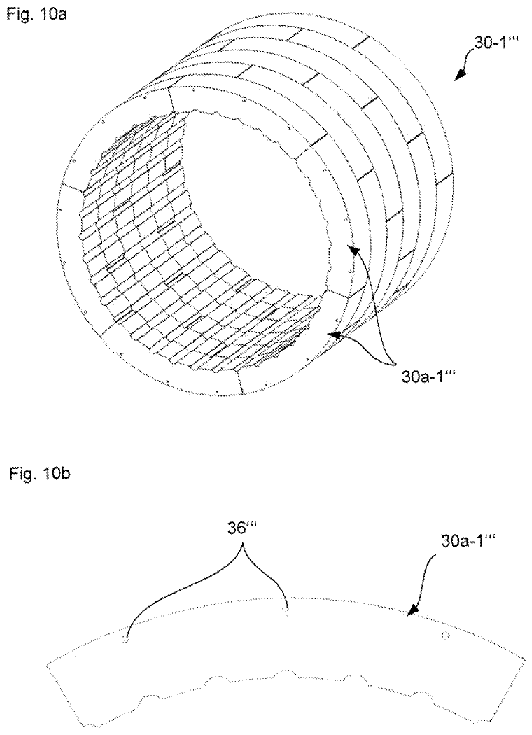

In FIGS. 10a, 10b, a segmented yoke ring 30-1′″ is shown according to a further modification, wherein the yoke ring 30-1′″ comprises a plurality of staggered yoke ring segments 30a-1′″. The staggered arrangement of the yoke ring segments 30a-1′″ ensures simplified assembly and high rigidity of the yoke ring at the same time.

Each of the yoke ring segments 30a-1′″ is provided with a plurality of bores 36′″ into each of which a rod made of a non-conductive material/a material with reduced electrical conductivity or a ground made of a curable, non-electrically conductive material is introduced in order to ensure a connection of the respective yoke ring segments in relation to each other in the axial direction. Thus, a cylindrical outer contour of the yoke ring is provided, wherein a segmentation and fixation is made possible, thus enabling grinding over and pressing into a housing.

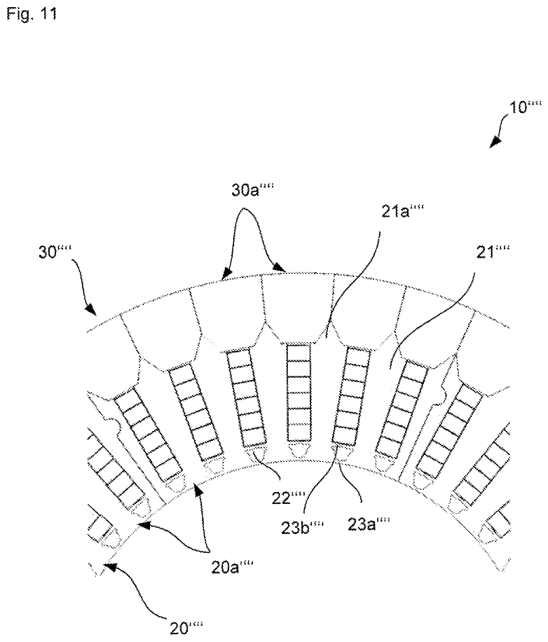

FIG. 11 shows a fourth embodiment of a portion of a stator 10″″ having a segmented yoke ring 30″″ as well as a segmented toothed star-shaped element 20″″. The toothed star-shaped element 20″″ has a plurality of teeth 21″″ comprising protrusions 21a″″ on an outer circumferential side. The protrusions 21a″″ can be inserted into recesses 31a″″ of the yoke ring 30″″ formed between yoke ring segments 30a″″ to connect the toothed star-shaped element 20″″ with the yoke ring 30″″.

The teeth 21″″ are spaced apart from each other in such a way that, in the assembled state, the windings with the insulation system can be accommodated in the grooves formed between the teeth 21″″. The teeth 21″″ are connected with each other by two bridges 23a″″, 23b″″, wherein the bridges 23a″″, 23b are formed between a groove and a recess 22″″ as well as the recess 22″″ and an inner circumferential side of the toothed star-shaped element 20″″. In the embodiment example, the recess 22″″ has a partially circular segment as well as a segment extending along the groove. For example, the bridges 23a″″, 23b″″ can be configured so as to be relatively thin by means of punching of the recess 22″″.

1. Stator for an electrical radial flux machine having an internal rotor design with a distributed winding, comprising:
a toothed star-shaped element having multiple teeth, wherein stator grooves are provided between the teeth in a circumferential direction and wherein the teeth are connected by means of one or more bridges in a region facing an air gap between the stator and the rotor; and
a yoke ring, wherein the toothed star-shaped element is accommodated, at least in sections, within the yoke ring.

2. The stator according to claim 1, wherein the toothed star-shaped element and/or the yoke ring has a plurality of segments in the circumferential direction.

3. The stator according to claim 2, wherein the toothed star-shaped element configured in a segmented manner, which is composed of a plurality of segments, is made of grain-oriented electrical steel sheet.

4. The stator according to claim 1, wherein the teeth of the toothed star-shaped element are connected by means of at least two bridges, and a recess is formed between the two bridges.

5. The stator according to claim 4, wherein cylindrical elements are located in the recess between the bridges.

6. The stator according to claim 5, wherein the elements formed as axially continuous tubes are formed in the recess between the bridges for guiding a cooling medium.

7. The stator according to claim 1, wherein the toothed star-shaped element is configured in such a way that the toothed star-shaped element, in addition to the segmentation around its circumference, is segmented by a plurality of rings in the axial direction.

8. The stator according to claim 5, wherein the elements configured as bolts having an axial length greater than the axial length of a segment of the toothed star-shaped element are located at intervals in a recess between the bridges.

9. The stator according to claim 1 wherein the segments of the toothed star-shaped element have connecting portions for mechanically fixing themselves to each other and in the yoke ring.

10. The stator according to claim 3 wherein a groove insulation for a winding is provided in the stator grooves, wherein the groove insulation is configured in two parts, wherein the segments of the toothed star-shaped element have a stepped recess.

11. The stator according to claim 1, wherein the yoke ring is configured in a segmented manner in such a way that the yoke ring segments have connecting portions for a form-fitting connection.

12. The stator according to claim 1, wherein the yoke ring is configured in a segmented manner in such a way that the yoke ring is segmented in the axial direction, wherein the yoke ring segments have eyelets for fixing the yoke ring as well as the stator by means of rods or tubes.

13. The stator according to claim 11, wherein the yoke ring segments are arranged so as to be interleaved with each other in the axial direction, wherein eyelets or connecting portions are alternately aligned.

14. The stator according to claim 1, wherein a winding with a distributed arrangement is accommodated in the stator grooves.

15. Electrical radial flux machine having an internal rotor design with a stator according to claim 1 as well as a rotor.

16. Method for assembling a stator for an electrical radial flux machine having an internal rotor design with a distributed winding, comprising the steps of:
providing a toothed star-shaped element having multiple teeth, wherein stator grooves are provided between the teeth in a circumferential direction and wherein the teeth are connected by means of one or more bridges in a region facing an air gap between the stator and the rotor; and
attaching a yoke ring along the rotational axis of the motor around the toothed star-shaped element.

17. The stator according to claim 3, wherein the preferred direction of the grain-oriented electrical steel sheet points in the direction of a rotational axis (R) of the stator.

18. The stator according to claim 4, wherein the recess is configured in a circular manner or limited by one or more partially circular contours.

19. The stator according to claim 5, wherein the cylindrical elements are bolts, rods and/or tubes.

20. The stator according to claim 5, wherein the cylindrical elements are electrically non-conductive or have reduced electrical conductivity.

21. The stator according to claim 7, wherein the segments of the toothed star-shaped element are arranged so as to be staggered with respect to each other in the axial direction.

22. The stator according to claim 8, wherein the intervals are regular intervals.

23. The stator according to claim 8, wherein axially successive segments of the toothed star-shaped element are alternately pinned together by means of the bolts.
